(19) United States
(12) Patent Application Publication
(10) Pub. No.: US 2009/0158924 A1
(43) Pub. Date: Jun. 25, 2009

(54) PISTON PUMP

(76) Inventors: Rene Schepp, Waiblingen (DE); Norbert Alaze, Markgroeningen (DE); Horst Beling, Heilbronn (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/301,680

(22) PCT Filed: Apr. 2, 2007
(86) PCT No.: PCT/EP2007/053178

§ 371 Date: Nov. 20, 2008

(30) Foreign Application Priority Data
May 26, 2006 (DE) 102006025027.3

(51) Int. Cl. F16J 15/18

(52) U.S. Cl. 92/165 R

(57) ABSTRACT

The present invention relates to a piston pump for feeding a fluid, having a piston and a pressure chamber which is arranged between an inlet valve and an outlet valve. The inlet valve has a closing element, a spring element for restoring the closing element, and a holding device. The holding device has a holding region for holding and supporting the spring element and an integrally formed sealing region in order to seal the pressure chamber with respect to a low-pressure region of the piston pump. The sealing region is of annular design and has a parting gap which is closed in an installed state.

### PRIOR ART

The present invention relates to a piston pump for pumping a fluid, having an improved holding device for holding an inlet valve.

Various embodiments of piston pumps are known from the prior art. Radial piston pumps are often used as piston pumps for vehicle brake systems; in them, at least one piston is movable back and forth by means of an eccentric element. The known piston pumps have a work or pressure chamber, disposed between an inlet valve and an outlet valve, in which chamber a pressure is built up by the motion of the piston. This pressure chamber must be sealed off on its end toward the piston from a low-pressure region of the piston. For that purpose, until now, separate piston rings have been used, which are preferably disposed on the piston. However, the result is a relatively large number of components for the piston pump. Moreover, separate guide rings are usually provided on the piston in order to furnish guidance of the piston in a pump housing.

### ADVANTAGES OF THE INVENTION

The piston pump of the invention having the characteristics of claim 1 has the advantage over the prior art that it is especially simple in construction and can be furnished economically. Moreover, the piston pump of the invention can be installed quickly and simply. This is attained according to the invention by providing that the piston pump has an inlet valve which is disposed on the piston. The inlet valve includes a closing element, a sealing element for restoring the closing element, and a holding device. The holding device is preferably embodied in cagelike form and includes a receiving region for receiving and bracing the sealing element and also includes an integrally formed sealing region. The sealing region assures sealing off of the pressure chamber from a low-pressure region of the pump. The sealing region is formed annularly and has a dividing point. In other words, the sealing region is in the form of a split ring, which is especially fast and easy to install. The sealing region is formed in one piece with the receiving region for the sealing element of the inlet valve, so that the number of parts can be reduced. The embodiment according to the invention thus offers major advantages, especially upon installation, since the installation of the inlet valve on the piston can now be done simply and with only a few manipulations. In the prior art, because of the many individual parts and especially because of the spring force of the sealing element of the inlet valve, there were always difficulties in installation, and the sealing element made the use of installation accessories necessary. In the present invention, such installation accessories can be dispensed with.

The dependent claims show preferred refinements of the invention.

Especially preferably, the sealing region of the holding device has spacer elements on its inner circumference. As a result, improved sealing can be attained, since the fluid under pressure located in the pressure chamber can act against the sealing region both in the axial direction and in the radial direction.

The spacer elements on the sealing region are preferably ribs disposed in the axial direction of the piston pump, which in the installed state are braced on the piston. The ribs are preferably embodied identically and are spaced equally apart from one another along the inner circumference.

The sealing region of the holding device is also preferably embodied as a guide element of the piston. As a result, besides its sealing function, the sealing region also has an additional function of guiding the piston. This has the major advantage that additional guide rings on the piston are no longer necessary. Thus on the one hand installation costs and on the other productions costs for the piston pump can be reduced significantly.

The sealing region of the holding device also preferably has a first end region and a second end region at the dividing point. The first and second end regions are formed such that they overlap in the circumferential direction of the sealing region.

In a further preferred embodiment of the invention, the first and second end regions of the sealing region overlap in the radial direction and/or the axial direction. As a result of the overlap in a the and/or the axial direction, improved sealing of the dividing point can be achieved, since the fluid under pressure in the pressure chamber can act for sealing purposes on the sealing region in the axial and/or the radial direction.

To enable especially economical production of the holding device of the inlet Valve, the holding device is preferably a plastic injection-molded part.

Also preferably, on its end toward the pressure chamber, the end on which the inlet valve is disposed, the piston includes an annular recess for receiving the sealing region of the holding device. The annular recess is preferably embodied as a step on the end of the piston.

### DRAWINGS

A preferred exemplary embodiment of the invention is described in conjunction with the accompanying drawings. In the drawings:

FIG. 1 is a schematic sectional view of a piston pump in an exemplary embodiment of the invention;

FIG. 2 is a perspective view of a holding device, shown in FIG. 1, of the inlet valve; and

FIG. 3 is a perspective fragmentary view of the holding device shown in FIG. 2.

### EMBODIMENTS OF THE INVENTION

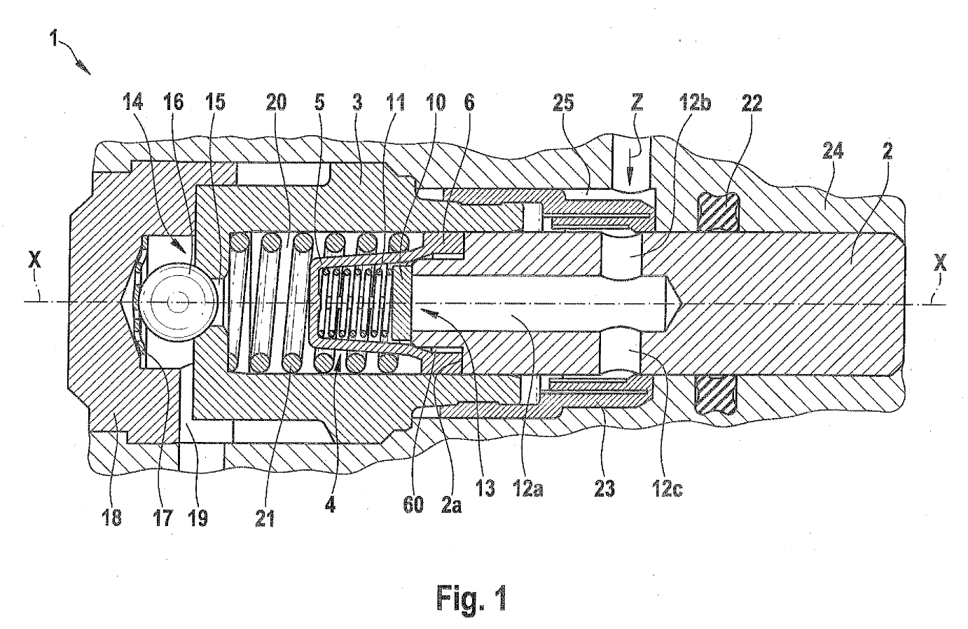

A preferred exemplary embodiment of a piston pump 1 of the invention will be described below in conjunction with FIGS. 1 through 3.

FIG. 1 schematically and in section shows the construction of the piston pump 1. The piston pump 1 includes a piston 2, which is movable back and forth in the axial direction X-X, for instance by means of an eccentric element. The piston 2 is disposed in a cylinder element 3. In the interior of the cylinder element 3, a pressure chamber 20 is provided, which is disposed between an inlet valve 13 and an outlet valve 14. As can be seen from FIG. 1, the inlet valve 13 is disposed in the interior of the pressure chamber 20, on the end of the piston 2 toward the pressure chamber. The outlet valve 14 is embodied as a check valve, which opens and closes a through opening 15. The outlet valve 14 includes a ball 16 and a diaphragm spring 17, which is braced on a closure element 18. The closure element 18 closes a stepped bore provided in the housing 24 of the piston pump.

The inlet valve 13 includes a closing element 10, in the form of a disklike plate; an inlet valve spring 11; and a holding device 4.

A delivery of a fluid to the pressure chamber 20 is effected, as can be seen from FIG. 1, through bores 12a, 12b and 12c from a feed line, the hydraulic fluid is delivered in the direction of the arrow Z through a filter 23 to the transverse bores 12b and 12c and, with the inlet valve 13 open, via the longitudinal bore 12a to the pressure chamber 20. In the housing 24, a seal 22 is also disposed on the piston 2, on the side toward the eccentric element.

Also disposed in the pressure chamber 20 is a cylindrical helical spring 21, which furnishes a restoring force for restoring the piston 2. The helical spring 21 furthermore assures that the piston always rests on the eccentric element. A pressure line 19 is hydraulically downstream of the outlet valve 14 and delivers the fluid under pressure, for instance to wheel brake cylinders of a vehicle brake system.

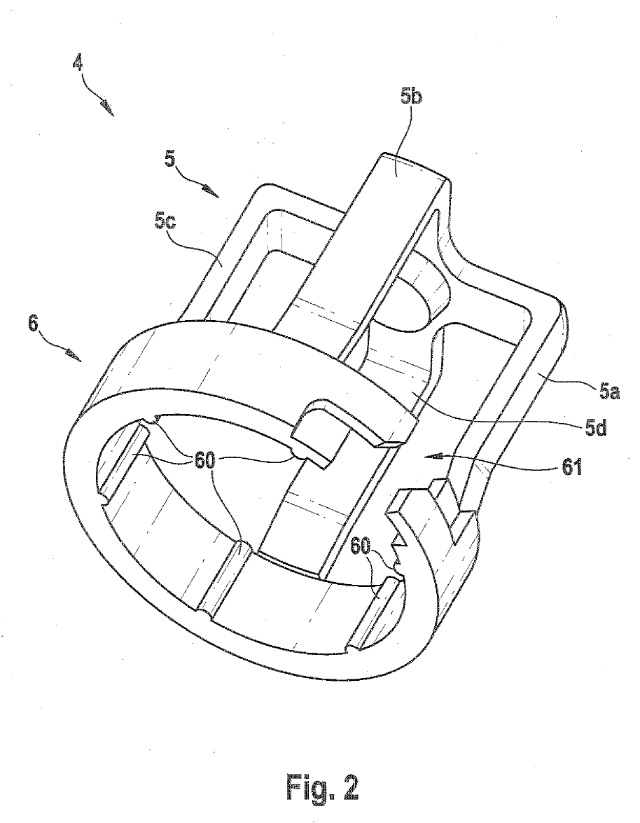

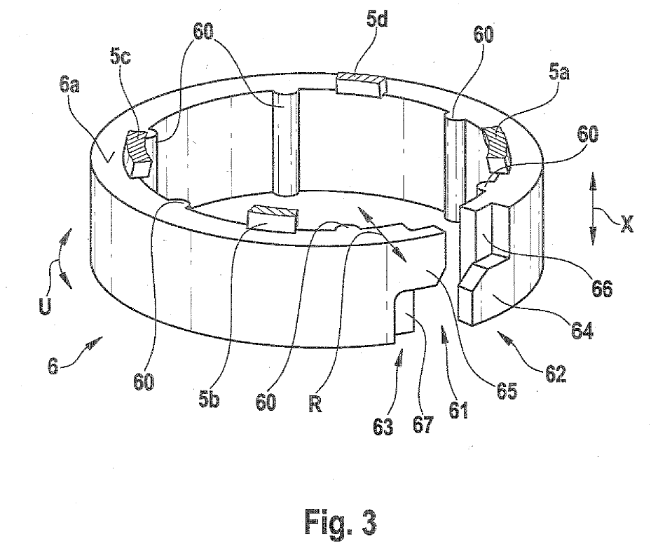

The holding device 4 of the inlet valve 13 is shown in detail in FIGS. 2 and 3. The holding device 4 includes a receiving region 5 for receiving the inlet valve spring 11 and a sealing region 6 for sealing off the pressure chamber 20 from the low-pressure region 25 of the piston pump in the region where the fluid is delivered. The receiving region 5 essentially has a cup-shaped, cagelike form. As can be seen from FIG. 2, the receiving region 5 includes four barlike elements 5a, 5b, 5c and 5d, which form a cage for the inlet valve spring 11. The inlet valve spring 11 is braced on the cross-shaped bottom region of the receiving region 5. For forming the bottom region, the barlike elements 5a, 5b, 5c and 5d are bent at an angle of approximately 90°. In addition, the four barlike elements 5a, 5b, 5c and 5d have a portion that is bent slightly outward in the axial direction, in the direction of the sealing region 6. The holding device 4 is preferably an injection-molded part, so that the receiving region 5 and the sealing region 6 are formed in one piece.

As can be seen from FIGS. 2 and 3, a plurality of spacer elements in the form of axial ribs 60 are formed on the inner circumference of the sealing region 6. In this exemplary embodiment, precisely six ribs 60 are provided. In the installed state, as can be seen from FIG. 1, the ribs 60 are braced on an annular shoulder 2a of the piston 2 on the end of the piston 2 toward the pressure chamber. The sealing region 6 further includes a dividing point 61, so that the sealing region 6 is formed as a split ring. It is understood that in the installed state, the dividing point 61 is closed. At the dividing point 61, the sealing region 6 thus has a first annular end region 62 and a second annular end region 63. The annular end regions 62, 63 each have one protruding tab 64 and 65 and one recess 66 and 67, respectively. The two annular end regions 62, 63 are formed such that in the installed state, they form a completely closed ring. As seen particularly in FIG. 3, the tabs 64, 65 and recesses 66, 67 thus form a connection of the dividing point 61, which has overlaps in the circumferential direction U, the axial direction X, and the radial direction R. As a result of these overlaps, it can be assured that the fluid under pressure located in the pressure chamber 20 furnishes an additional sealing action in both the axial direction and the radial direction. The ribs 60 assure that fluid under pressure in the pressure chamber contacts the inner circumference of the sealing region 6. Fluid under pressure likewise contacts the annular face 6a oriented toward the pressure chamber. As a result, the sealing region 6 is pressed against the shoulder 2a of the piston by the pressure force in the pressure chamber 20.

The sealing region 6 furthermore has a guiding function, for guiding the piston 2 in the cylinder element 3. As a result, separate guide rings on the piston 2 can be dispensed with.

It should also be noted that as a result of the sealing region 6 formed as a split ring, simple preassembly of the inlet valve 13 on the pressure end of the piston 2 can be accomplished. Thus the piston 2, with the preassembled inlet valve 13, can be furnished as a preassembled unit. For the final installation, the piston together with the inlet valve 13 then need merely be introduced into the housing 24 of the piston pump.

1-9. (canceled)

10. A piston pump for pumping a fluid, comprising:
a piston and a pressure chamber that is disposed between an inlet valve and an outlet valve, the inlet valve includes a closing element, a restoring element for restoring the closing element, and a holding device; wherein the holding device includes a receiving region for receiving and bracing the restoring element and also includes an integrally formed sealing region for sealing off the pressure chamber from a low-pressure region of the piston pump; and wherein the sealing region is formed annularly and has a dividing gap.

11. The piston pump as defined by claim 10, wherein the sealing region of the holding device has spacer elements on its inner circumference.

12. The piston pump as defined by claim 10, wherein the spacer elements are ribs, which are disposed in an axial direction of the piston pump and which in the installed state are braced on the piston.

13. The piston pump as defined by claim 10, wherein the sealing region is also embodied as a guide element of the piston.

14. The piston pump as defined by claim 11, wherein the sealing region is also embodied as a guide element of the piston.

15. The piston pump as defined by claim 12, wherein the sealing region is also embodied as a guide element of the piston.

16. The piston pump as defined by claim 10, wherein at the dividing gap the sealing region has a first annular end region and a second annular end region, and the first and second annular end regions overlap in a circumferential direction of the sealing region.

17. The piston pump as defined by claim 11, wherein at the dividing gap the sealing region has a first annular end region and a second annular end region, and the first and second annular end regions overlap in a circumferential direction of the sealing region.

18. The piston pump as defined by claim 12, wherein at the dividing gap the sealing region has a first annular end region and a second annular end region, and the first and second annular end regions overlap in a circumferential direction of the sealing region.

19. The piston pump as defined by claim 16, wherein the first annular end region and the second annular end region overlap in the radial direction of the sealing region.

20. The piston pump as defined by claim 17, wherein the first annular end region and the second annular end region overlap in the radial direction of the sealing region.

21. The piston pump as defined by claim 18, wherein the first annular end region and the second annular end region overlap in the radial direction of the sealing region.

22. The piston pump as defined by claim 16, wherein the first annular end region and the second annular end region overlap in the axial direction of the sealing region.

23. The piston pump as defined by claim 17, wherein the first annular end region and the second annular end region overlap in the axial direction of the sealing region.

24. The piston pump as defined by claim 18, wherein the first annular end region and the second annular end region overlap in the axial direction of the sealing region.

25. The piston pump as defined by claim 19, wherein the first annular end region and the second annular end region overlap in the axial direction of the sealing region.

26. The piston pump as defined by claim 20, wherein the first annular end region and the second annular end region overlap in the axial direction of the sealing region.

27. The piston pump as defined by claim 21, wherein the first annular end region and the second annular end region overlap in the axial direction of the sealing region.

28. The piston pump as defined by claim 10, wherein the holding device is a plastic injection-molded part.

29. The piston pump as defined by claim 10, wherein the piston, on its end toward the pressure chamber, has an annular recess for receiving the sealing region of the holding device.
